(19) United States
(12) Patent Application Publication
(10) Pub. No.: US 2009/0127805 A1
(43) Pub. Date: May 21, 2009

(54) Assembly for Sealing a Component and Method

(75) Inventor: Robert Philip Benjey, Dexter, MI (US)

Correspondence Address: QUINN LAW GROUP, PLLC, 39555 ORCHARD HILL PLACE, SUITE # 520, NOVI, MI, 48375, US

(73) Assignee: Eaton Corporation, Cleveland, OH (US)

(21) Appl. No.: 11/943,218

(22) Filed: Nov. 20, 2007

(51) Int. Cl. F16J 15/10; B29C 49/50

(52) U.S. Cl. 277/627; 264/279.1

(57) ABSTRACT

An assembly is provided that has a first component at least partially defining a first generally tubular cavity or channel. A barrier layer is embedded within the first component to separate the first component into an inner layer and an outer layer. The first component has a terminal end at which the barrier layer is exposed to the first cavity. A second component at least partially defines a second cavity. The second component is positioned with respect to the first component such that the first cavity is in communication with the second cavity. A seal is used to seal the second component to the first component substantially at the barrier layer. The barrier layer and the seal thereby block at least some of the first component from permeation from the first cavity. A method is also provided.

### TECHNICAL FIELD

The invention relates to an assembly for sealing a component and to a method of sealing components, specifically blow-molded components.

### BACKGROUND OF THE INVENTION

Various materials may be used in applications in which the components may come into contact with liquids and vapors, such as hydrocarbon fuel, that must be sealingly retained within the system. Certain materials, such as some plastics, are more permeable than other materials. When materials with a relatively high permeability are assembled with materials of lower permeability, the overall permeation through the assembly will be a function of the more permeable material, as hydrocarbon vapor and liquid will seek a path of least resistance through the assembly.

Plastic components are often blow-molded. During the blow-molding process, pressure is exerted within a mold to force the plastic outward, forming the plastic to the shape of the mold.

### SUMMARY OF THE INVENTION

An assembly is provided that enhances the sealing ability of dissimilar materials against unwanted permeation, such as hydrocarbon vapor permeation. Specifically, an assembly is provided that has a first component at least partially defining a first generally tubular cavity or channel. A barrier layer is embedded within the first component to separate the first component into an inner layer and an outer layer. The first component has a terminal end at which the barrier layer is exposed to the first cavity. A second component at least partially defines a second cavity. The second component is positioned with respect to the first component such that the first cavity is in communication with the second cavity. A seal, which may be annular, is used to seal the second component to the first component substantially at the barrier layer. The barrier layer and the seal thereby block at least some of the first component from permeation from the first cavity.

Furthermore, a method is provided that includes cutting a generally tubular portion of a multi-layer blow-molded component with a vapor barrier layer embedded within the blow-molded component. The vapor barrier layer is less permeable than the blow-molded component. Next, the method includes sealing a second component to the blow-molded component by placing a seal substantially adjacent the barrier layer, in contact with and between the second component and the blow-molded component, thereby at least partially preventing permeation from the first cavity through the blow-molded component.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration in cross-sectional view of a blow-molded tubular component with a barrier layer embedded therein;

FIG. 2 is a schematic illustration in cross-sectional view of a fill pipe assembly operatively connected to a fuel tank, including the blow-molded tubular component of FIG. 1 after cutting the tubular component to define a terminal end that exposes the barrier layer, with a second component sealed to the tubular component;

FIG. 3 is a schematic illustration in cross-sectional view of another embodiment of a fill pipe assembly operatively connected to a fuel tank; and

FIG. 4 is a schematic illustration in cross-sectional view of another embodiment of a fill pipe assembly with a tubular component sealed to another component.

### DESCRIPTION OF THE PREFERRED EMBODIMENTS

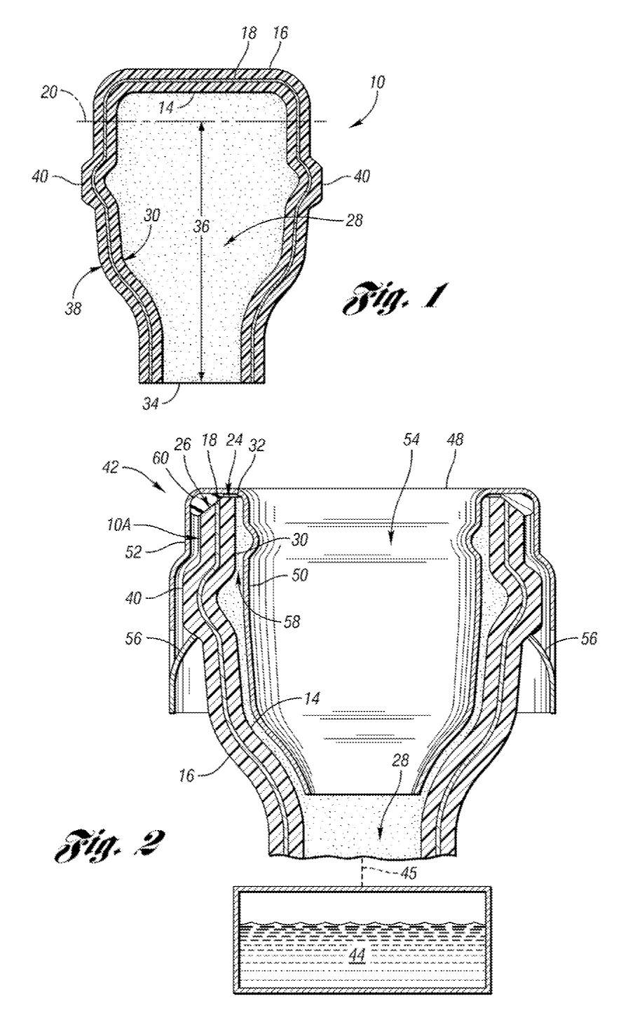

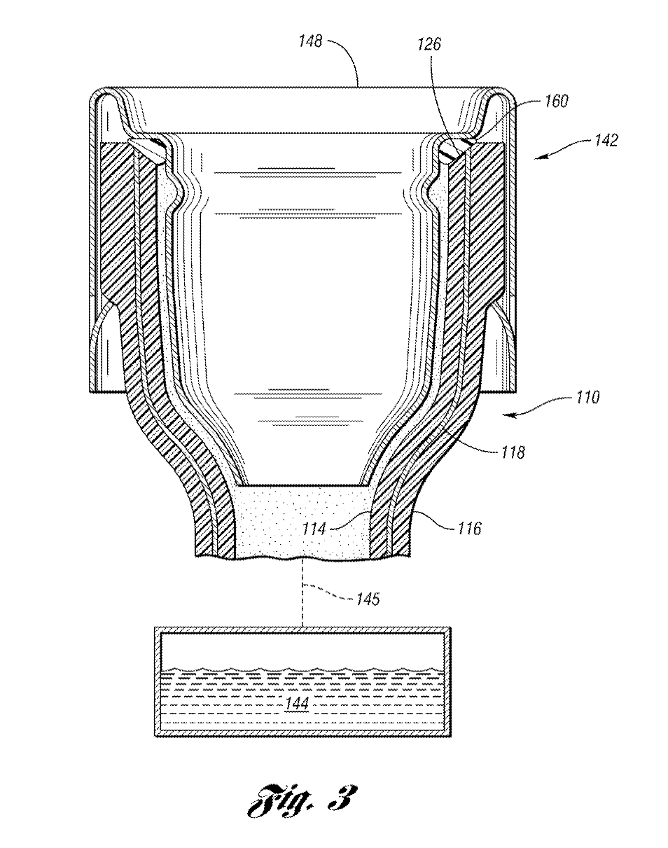

Referring to the drawings, wherein like reference numbers refer to like components, FIG. 1 shows a blow-molded first component 10. The first component 10 has an inner layer or portion 14 and an outer layer or portion 16 with a barrier layer 18 embedded therebetween. The inner and outer portions 14, 16 may be a plastic material, such as a high density polyethylene (HDPE) material. The barrier layer 18 is embedded by blow-molding the material of the inner and outer portions 14, 16 on either side of the barrier layer within a mold (not shown). Thus, the barrier layer 18 is embedded lengthwise in the first component 10. The barrier layer 18 may be a thin film and has lower hydrocarbon permeability than the material of the inner and outer portions 14, 16, also referred to an inner layer and an outer layer, respectively. Thus, the barrier layer 18 prevents hydrocarbons permeating through the inner portion 14 from permeating through the barrier layer 18 to the outer portion 16. Specifically, the barrier layer 18 may be an ethylene vinyl alcohol copolymer (EVOH) material, or any other material with relatively low hydrocarbon vapor permeability. After blow-molding, the component 10 is cut approximately along the line 20 to remove a closed end of the component (shown as an upper end as viewed in FIG. 1) to establish an end surface 24 shown in FIG. 2. The component 10 is also cut, chamfered or otherwise machined at the surface 24, either in the same step as cutting along the line 20 or in a separate step, to establish an outwardly tapered end surface 26 shown in FIG. 2. Once cut, a generally tubular cavity or channel 28 defined by an inner surface 30 of the first component 10 is open at a first end 32 (partially visible in FIG. 2) and at a second end 34 (shown in FIG. 1) so that the component 10 now is referred to as tube 10A, with a length 36 between the ends 32, 34. The barrier layer 18 is exposed at the end surface 26, as shown in FIG. 2. Referring again to FIG. 1, the first component 10 is blow-molded in a mold so that the outer surface 38 of the first component 10 has a peripheral protrusion 40.

Referring to FIG. 2, the tube 10A is incorporated in a fill pipe assembly 42, which may be a capless-type fill pipe assembly or a fill pipe assembly utilizing a fuel cap. In either instance, componentry attaching near the end 32 of the tube 10A for a capless or a capped assembly is not shown. The tube 10A is operatively connected to a fuel tank 44 by additional tubing or passages, as indicated by the dashed line 45 in FIG. 2.

Although in this embodiment the tube 10A is a fill pipe for the fuel tank 44, other components are contemplated within the scope of the invention, such as a boss or tubular extension integrally formed with a fuel tank and forming a generally tubular cavity extending to a fuel tank vent valve or other fuel system component. For example, the tube 10A may be an integral extension of the fuel tank 44, blow-molded with the fuel tank 44, with the end 34 opening into the tank 44. Blow-molded plastic components that are not related to fuel systems are also contemplated within the scope of the invention.

The fill pipe assembly 42 also includes a second component which is a fill cup 48 into which a fuel nozzle (not shown) is inserted to fill the fuel tank 44. The fill cup 48 may be any material, such as metal or a plastic, including polyphenylene sulfide (PPS), polyoxymethylene (POM), polyphtalamide (PPA), or another type of low permeation plastic, as long as the material has a lower vapor permeability than the inner and outer portions 14, 16 of the tube 10A. The fill cup 48 has an inner annular extension 50 and an outer annular extension 52. The inner annular extension 50 defines an internal second cavity 54 that overlaps with and is in fluid communication with the channel 28 of the tube 10A. The outer annular extension 52 has tab extensions 56 that are formed or bent to extend inward, and are configured to interfere with the protrusion 40 of the tube 10A to connect the fill cup 48 to the tube 10A.

In order to prevent permeation of hydrocarbon vapor from the cavity 28 outward past the vapor barrier layer 18, a seal 60, which in this embodiment is annular, and is referred to herein as annular seal 60, is placed in contact with the end surface 26 over the exposed barrier layer 18 and in contact with the fill cup 48. The annular seal 60 may be a fluorocarbon rubber (FKM) material. The annular seal 60 is compressed between the fill cup 48 and the end surface 26, and has a large footprint (i.e., contact area) between the fill cup 48 and the tube 10A. Thus, even if the exact location of the exposed barrier layer 18 varies slightly from component to component, the large contact area of the annular seal 60 used will ensure sealing contact. The tapered nature of the end surface 26 helps to wedge the annular seal 60 securely in a sealing position between the fill cup 48 and the tube 10A over the barrier layer 18. Thus, the contacting fill cup 48, annular seal 60 and tube 10A align to prevent permeation of hydrocarbon vapor outward past these components. For example, the fill cup 48, annular seal 60 and barrier layer 18 prevent hydrocarbon vapor from reaching the outer portion 16 of the tube 10A. Hydrocarbon permeation from the fill pipe assembly 42 is expected to be less than 2 milligrams per day, whereas a similar assembly without a barrier layer 18 or without the seal 60 positioned as described herein with respect to the barrier layer 18 and fill cup 48 will have a much higher hydrocarbon permeation rate (e.g., greater than 20 milligrams per day). For example, HDPE, which may be the material used for the inner and outer portions 14, 16, has a fuel permeation rate of approximately 56 gm-mm per square meter per day for a CE10 fuel at 40 degrees Celsius. EVOH, which may be the material used for the barrier layer 18, has a fuel permeation rate of approximately 2 gm-mm per square meter per day for a CE10 fuel at 40 degrees Celsius. FKM, which may be the material used for the annular seal 60, has a fuel permeation rate of approximately 20 gm-mm per square meter per day for a CE10 fuel at 40 degrees Celsius.

It is expected that the inner portion 14, especially if plastic, will swell when contacted with hydrocarbon based liquid fuel or vapor. The inner annular extension 50 is configured to be in close proximity to the inner portion 14, with a small radial gap 58 between the two to control creep of the tube 10A due to swelling of the inner portion 14.

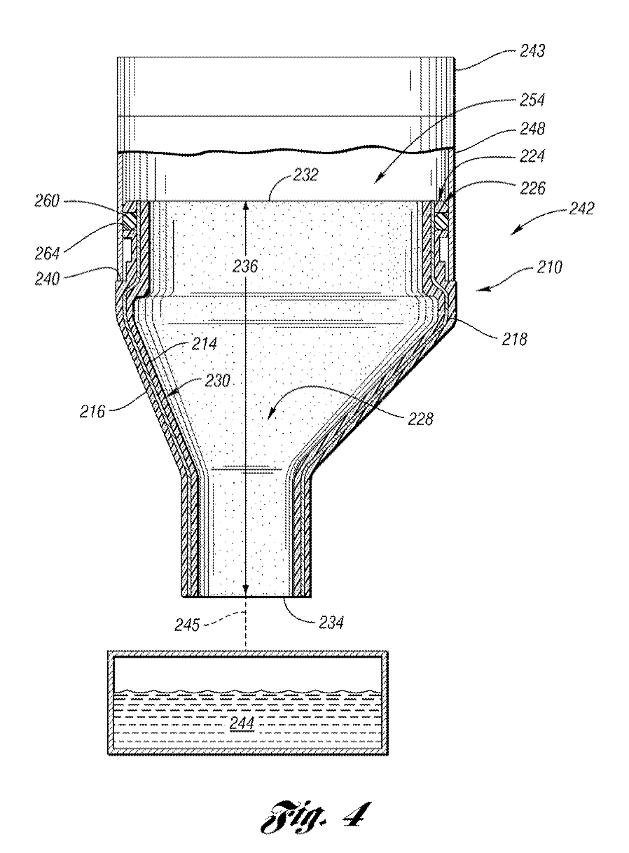

Referring to FIG. 3, another embodiment of a fill pipe assembly 142 is illustrated that includes a fill cup 148 similar to fill cup 48, an annular seal 160 similar to annular seal 60, and a tube 110 (i.e., first component) with a barrier layer 118, similar to tube 10A and barrier layer 18, except that a tapered end surface 126 is inwardly tapered rather than outwardly tapered. The fill pipe assembly 142 is operatively connected to a fuel tank 144 by additional tubing or passages as indicated by the dashed line 145. Alternatively, the tube 110 may be an integrally-formed extension of the tank 144, blow-molded with the tank 144, with the barrier layer 118 also embedded within the walls of the tank 144. The contacting fill cup 148, annular seal 160 and barrier layer 118 prevent hydrocarbon permeation from the inner layer or portion 114 to the outer layer or portion 116 of the tube 110.

FIG. 4 shows another embodiment of a fill pipe assembly 242 operatively connected to a fuel tank 244. The fill pipe assembly 242 includes a blow-molded first component, also referred to as tube 210, with a barrier layer 218 embedded between an inner layer or portion 214 and an outer layer or portion 216 of the tube 210. The fill pipe assembly 242 also includes a second component which is a tube 248 of a plastic, metal or other material with a permeability less than that of the tube 210. The tube 248 may connect to another component 243 such as a cap, components for a capless fueling system, a valve housing, or other components operatively connected to a fuel tank 244 by additional tubing or passages as indicated by dashed line 245. The barrier layer 218 is exposed at an end surface 224 of the tube 210 where the tube 210 is cut after blow-molding. The tube 210 is also cut, chamfered or otherwise machined at end surface 224, either in the same step as cutting to form surface 224 or in a separate step, to establish an outwardly tapered end surface 226. The outwardly tapered end surface 226 is for ease of assembly in placing the metal tube 248 around the first component 210. A channel 228 defined by an inner surface 230 of the tube 210 is open at a first end 232 and a second end 234 with a length 236 between the ends 232, 234. Alternatively, the tube 210 may be an integrally-formed extension of the tank 244, blow-molded with the tank 244, with the barrier layer 218 also embedded within the walls of the tank 244.

The barrier layer 218 is of a lower hydrocarbon permeability than the material used in the inner portion 214 and the outer portion 216 of the tube 210 and serves to prevent permeation of hydrocarbon vapors in the channel 228 past the inner portion 214 through the barrier layer 218 to the outer portion 216. The hydrocarbon permeability of the metal tube 248 is less than the hydrocarbon permeability of the tube 210. For example, if the tube 248 is metal, the hydrocarbon permeability is substantially zero. The tube 248 defines a cavity 254 that communicates with and overlaps the channel 228. The tube 210 has a protrusion 240 which physically interferes with the tube 248. The tube 210 has an annular recess 264 in which a seal 260, which in this embodiment is annular, is placed. The annular seal 260 is compressible between the tube 210 and the tube 248. The annular recess 264 may be formed by machining after blow-molding of the tube 210. The annular recess 264 abuts the barrier layer 218 or extends inward substantially close to the barrier layer 218 so that when the seal 260 is in the recess 264, the barrier layer 218, the seal 260 and the metal tube 248 align to substantially prevent hydrocarbon permeation through the inner portion 214 to the outer portion 216. Because there may be some variation in the exact radial position of the barrier layer 218 in the tube 210 with respect to the annular recess 264 due to manufacturing tolerances from component to component, the recess 264 may in some cases not extend completely inward to the barrier layer 218. In those cases, the seal 260 will not be in contact with the barrier layer 218 when the seal 260 is in the recess 264, but will still substantially reduce the exposure of the outer portion 216 to vapor permeation between the seal 260 and the barrier layer 218.

While the best modes for carrying out the invention have been described in detail, those familiar with the art to which this invention relates will recognize various alternative designs and embodiments for practicing the invention within the scope of the appended claims.

1. An assembly comprising:
a first component at least partially defining a first generally tubular cavity;
a barrier layer embedded within the first component to separate the first component into an inner layer and an outer layer;
wherein the first component has a terminal end with an end surface at which the barrier layer is exposed to the first cavity;
a second component at least partially defining a second cavity; wherein the second component is positioned with respect to the first component such that the first cavity is in communication with the second cavity;
a seal sealing the second component to the first component; and wherein the seal contacts the second component and the first component substantially at the barrier layer, the barrier layer and seal thereby blocking at least some of the outer layer of the first component from vapor permeation from the first cavity.

2. The assembly of claim 1, wherein the seal is an annular seal; wherein the first component has an outer surface with a recess circumscribing the barrier layer; and
wherein the seal is in recess.

3. The assembly of claim 1, wherein the seal contacts the barrier layer at the end surface.

4. The assembly of claim 1, wherein the first component has an outer surface with a protrusion; and wherein the second component has an extension configured to interfere with the protrusion to connect the first component to the second component.

5. The assembly of claim 1, wherein the second component has an inner annular extension within the first cavity and an outer annular extension at least partially surrounding the first component.

6. The assembly of claim 1 in combination with a fuel tank, wherein the first component is an extension of the fuel tank.

7. An assembly comprising:
a first component having an inner surface and an outer surface; wherein the inner surface defines an elongated channel with a length;
a vapor barrier layer within the first component between the inner surface and the outer surface along the length; wherein the vapor barrier layer is less permeable than the first component;
wherein the first component has a terminal end with an end surface at which the vapor barrier layer is exposed to the channel;
a second component defining an internal cavity; wherein the second component is less permeable than the first component; wherein the second component is positioned adjacent to the first component such that the channel overlaps the internal cavity;
a seal positioned in sealing contact with the second component and the first component substantially adjacent the vapor barrier layer to substantially restrict hydrocarbon permeation from the channel through at least a portion of the first component between the vapor barrier layer and the outer surface.

8. The assembly of claim 7, wherein the first component has a recess in the outer surface circumscribing the vapor barrier layer; and
wherein the seal is in recess.

9. The assembly of claim 7, wherein the seal contacts the barrier layer at the end surface.

10. The assembly of claim 7, wherein the end surface is tapered inward toward the channel.

11. The assembly of claim 7, wherein the end surface is tapered outward away from the channel.

12. The assembly of claim 7, wherein the first component has a protrusion at the outer surface; and wherein the second component has an extension configured to interfere with the protrusion to further connect the second component to the first component.

13. The assembly of claim 7, wherein the second component is metal.

14. The assembly of claim 7, wherein the second component is one of polyphenylene sulfide, polyoxymethylene, and polyphtalamide.

15. The assembly of claim 7 in combination with a fuel tank; and wherein the first component is an extension of the fuel tank.

16. The assembly of claim 7, wherein the second component has an inner annular extension within the channel and an outer annular extension surrounding the first component.

17. A method comprising:
cutting a generally tubular portion of a multi-layer blow-molded component to thereby expose a first cavity formed by the blow-molded component and expose a vapor barrier layer embedded within the blow-molded component; and
sealing a second component to the blow-molded component by placing a seal substantially adjacent the barrier layer, in contact with and between the second component and the blow-molded component to thereby at least partially prevent permeation from the first cavity through the blow-molded component.

18. The method of claim 17, further comprising:
prior to said sealing, machining a recess in the blow-molded component; and wherein the seal is placed in the recess.

19. The method of claim 17, further comprising:
prior to said cutting, blow-molding plastic on either side of the barrier layer to embed the barrier layer within the plastic and thereby form the blow-molded component.
